(19) United States
(12) Patent Application Publication
(10) Pub. No.: US 2026/0177403 A1
(43) Pub. Date: Jun. 25, 2026

(54) Generation of Multi-Dimensional Content Slots to Increase Display Availability of User Interfaces

(71) Applicant: Google LLC, Mountain View, CA (US)

(72) Inventors: Puneetha Pai Brahmavar Pattanshet, Brahmavar, Udupi District, Karnataka (IN); Ramprasad Sedouram, Bangalore, Karnataka (IN)

(21) Appl. No.: 18/849,297

(22) PCT Filed: Mar. 21, 2023
(86) PCT No.: PCT/US2023/015771

§ 371 Date: Sep. 20, 2024

(51) Int. Cl. G01C 21/00

(52) U.S. Cl. CPC G01C 21/3867; G01C 21/3815

(57) ABSTRACT

Example embodiments of the present disclosure provide for an example method that includes obtaining data indicative of a user initiating a map application instance on a client device. The method includes determining multi-dimensional geographic content slots for content items to populate by determining geographic boundaries associated with geographic areas. The method includes generating a shape that aligns with the geographic boundaries and generating a multi-dimensional content item slot that aligns with the shape that aligns with the geographic boundary. The method includes determining a content item to populate within the multi-dimensional geographic content slot. The method includes providing the content item to the client device to be displayed within the multi-dimensional geographic content slot in the user interface of the client device associated with the map application instance.

### FIELD

The present disclosure relates generally to integration of content within a user interface. More particularly, the present disclosure relates to generating multi-dimensional geographic content slots to increase display availability of user interfaces.

### BACKGROUND

Map interfaces can be associated with map applications for providing visual representations of geographic areas. Map interfaces can include navigation interfaces used for presenting directions from a first location to a second location.

### SUMMARY

Aspects and advantages of embodiments of the present disclosure will be set forth in part in the following description, or can be learned from the description, or can be learned through practice of the embodiments.

In one example aspect, the present disclosure provides for an example system for integration of content within a navigation interface based on contextual data including one or more processors and one or more memory device storing instructions that are executable to cause the one or more processors to perform operations. In some implementations, the one or more memory devices can include one or more transitory or non-transitory computer-readable media storing instructions that are executable to cause the one or more processors to perform operations. In the example system, the operations can include obtaining data indicative of a user initiating a map application instance on a client device. The operations can include determining one or more multi-dimensional geographic content slots for content items to populate by determining a first geographic boundary associated with a geographic area associated with the map application instance. The operations can include determining one or more multi-dimensional geographic content slots for content items to populate by generating a shape that aligns with the first geographic boundary. The operations can include determining one or more multi-dimensional geographic content slots for content items to populate by generating at least one multi-dimensional geographic content slot that aligns with the shape that aligns with the first geographic boundary. The operations can include determining a content item to populate within the at least one multi-dimensional geographic content slot. The operations can include providing the content item to the client device to be displayed via the at least one multi-dimensional geographic content slot in a user interface of the client device associated with the map application instance.

In some embodiments of the example system, wherein determining the one or more multi-dimensional geographic content slots for the content items to populate comprises, generating a multi-dimensional geographic content slot such that the content item provided to be displayed via the content slot will not obstruct the map application instance.

In some embodiments of the example system, the operations include in response to determining the at least one multi-dimensional geographic content slot, generating the content item using a generative model.

In some embodiments of the example system, the generative model includes at least one of (i) image generation model, (ii) audio-visual generation model, or (iii) audio generation model.

In some embodiments of the example system, determining the one or more multi-dimensional geographic content slots for the content items to populate further includes determining a second geographic boundary; generating a shape that aligns with the second geographic boundary; and generating a multi-dimensional geographic content slot in the shape that aligns with the second geographic boundary.

In some embodiments of the example system, at least one of the first geographic boundary or the second geographic boundary comprises at least one of (i) a road, (ii) a building, (iii) a body of water, (iv) a mountain, or (v) an undeveloped area.

In some embodiments of the example system, the first geographic boundary comprises a road, and wherein determining the one or more multi-dimensional geographic content slots includes obtaining data indicative of an event that restricts the road to pedestrian-only use; and in response to obtaining the data indicative of the event that restricts the road to pedestrian-only use, determining that the multi-dimensional geographic content slot can include the road without decreasing opacity of the content item to make the road visible via the user interface.

In some embodiments of the example system, the map application instance comprises a navigation instance, and wherein determining the one or more multi-dimensional geographic content slots for content items to populate includes determining a first content slot associated with a geographic location comprising a plurality of roads, wherein at least one road of the plurality of roads is associated with the navigation instance; determining a second multi-dimensional geographic content slot associated with the geographic location comprising a water feature; and selecting the second content slot to display a content item based on the first multi-dimensional geographic content slot being associated with the at least one road associated with the navigation instance.

In some embodiments of the example system, the content item for the at least one multi-dimensional geographic content slot is determined based on a real-time bidding process.

In some embodiments of the example system, the content item is related in subject matter to a geographic area associated with the at least one multi-dimensional geographic content slot.

In some embodiments of the example system, the at least one multi-dimensional geographic content slot is generated based on being at least one of (i) non-disturbing visually to a navigation instance, (ii) making use of a store location, or (iii) determining a geographic location is pedestrian only for predetermined length of time.

In some embodiments of the example system, the operations include determining that the map application instance is an exploration instance; and in response to determining the map application instance is an exploration instance, populating a plurality of the one or more multi-dimensional geographic content item slots with a plurality of determined content items.

In an example aspect, the present disclosure provides for an example computer-implemented method. The example method includes obtaining data indicative of a user initiating a map application instance on a client device. The method includes determining one or more multi-dimensional geographic content slots for content items to populate by determining a first geographic boundary associated with a geographic area associated with the map application instance. The method includes determining one or more multi-dimensional geographic content slots for content items to populate by generating a shape that aligns with the first geographic boundary. The method includes determining one or more multi-dimensional geographic content slots for content items to populate by generating at least one multi-dimensional geographic content slot that aligns with the shape that aligns with the first geographic boundary. The method includes determining a content item to populate within the at least one multi-dimensional geographic content slot. The method includes providing the content item to the client device to be displayed via the at least one multi-dimensional geographic content slot in a user interface of the client device associated with the map application instance.

In some embodiments of the example method, the method includes determining that the map application instance is a navigation instance; and in response to determining that the map application instance is a navigation instance, determining the at least one content slot that does not overlay content on a road associated with the navigation instance.

In some embodiments of the example method, the method includes determining that a navigation application has launched; determining that the display of the navigation application has remained static for a threshold amount of time; comparing the amount of time to the threshold amount of time; determining the amount of time exceeds the threshold amount of time; and in response to determining that the amount of time exceeds the threshold time, determining the one or more content item slots.

In some embodiments of the example method, determining the content item to populate within the at least one multi-dimensional geographic content slot includes generating the content item for the at least one multi-dimensional geographic content slot based on a shape of the at least one multi-dimensional geographic content slot.

In some embodiments of the example method, the content item to populate within the at least one multi-dimensional geographic content slot includes identifying an existing content item comprising a plurality of portions; determining, by analyzing the content item, a portion of the content item containing information of interest; determining the at least one multi-dimensional geographic content slot is a shape that would crop the content item to exclude the portion of the content item containing information of interest; and in response to determining the at least one multi-dimensional geographic content slot shape would crop the content item to exclude the portion of the content item containing information of interest, generating a new content item in the shape of the at least one multi-dimensional geographic content slot that includes the information of interest.

In some embodiments of the example method, generating a new content item in the shape of the at least one multi-dimensional geographic content slot that includes the information of interest includes extracting text from the existing content item; extracting an image from the existing content item; and generating the new content item to include the extracted text and extracted image from the existing content item.

In some embodiments of the example method, determining the content item to populate within the at least one multi-dimensional geographic content slot includes generating the content item based on at least one of (i) content slot data, (ii) user data, or (iii) personalized user information.

In an example aspect, the present disclosure provides for an example transitory or non-transitory computer readable medium embodied in a computer-readable storage device and storing instructions that, when executed by a processor, cause the processor to perform operations. In the example transitory or non-transitory computer readable medium, the operations include obtaining data indicative of a user initiating a map application instance on a client device. In the example transitory or non-transitory computer readable medium, the operations include determining, by the computing system, one or more multi-dimensional geographic content slots for content items to populate by determining a first geographic boundary associated with a geographic area associated with the map application instance; generating a shape that aligns with the first geographic boundary; and generating at least one multi-dimensional geographic content slot that aligns with the shape that aligns with the first geographic boundary. In the example transitory or non-transitory computer readable medium, the operations include determining, by the computing system, a content item to populate within the at least one multi-dimensional geographic content slot. In the example transitory or non-transitory computer readable medium, the operations include providing the content item to the client device to be displayed via the at least one multi-dimensional geographic content slot in a user interface of the client device associated with the map application instance.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a flow chart diagram of example data flow according to example embodiments of the present disclosure.

FIG. 2 depicts an example user interface according to example embodiments of the present disclosure.

FIG. 3A depicts an example user interface according to example embodiments of the present disclosure.

FIG. 3B depicts an example user interface according to example embodiments of the present disclosure.

FIG. 3C depicts an example user interface according to example embodiments of the present disclosure.

FIG. 3D depicts an example user interface according to example embodiments of the present disclosure.

FIG. 3E depicts an example user interface according to example embodiments of the present disclosure.

FIG. 3F depicts an example user interface according to example embodiments of the present disclosure.

FIG. 4A depicts an example user interface according to example embodiments of the present disclosure.

FIG. 4B depicts an example user interface according to example embodiments of the present disclosure.

FIG. 5A depicts an example user interface according to example embodiments of the present disclosure.

FIG. 5B depicts an example user interface according to example embodiments of the present disclosure.

FIG. 6A depicts a flow chart diagram of an example method to generate multi-dimensional content slots to increase display availability of user interfaces according to example embodiments of the present disclosure.

FIG. 6B depicts a flow chart diagram of an example method to generate multi-dimensional content slots to increase display availability of user interfaces according to example embodiments of the present disclosure.

FIG. 7A depicts a block diagram of an example computing system that performs integration of content within the navigation interface based on contextual data according to example embodiments of the present disclosure.

FIG. 7B depicts a block diagram of an example computing device that performs integration of content within the navigation interface based on contextual data according to example embodiments of the present disclosure.

FIG. 7C depicts a block diagram of an example computing device that performs integration of content within the navigation interface based on contextual data according to example embodiments of the present disclosure.

### DETAILED DESCRIPTION

The present disclosure generally relates to generating multi-dimensional geographic content slots to increase display availability of user interfaces. For instance, this can provide for expanding the available display area to increase the information that can be provided for display via an interface of a client device such as map user interface (e.g., associated with a navigation application).

A map user interface can have a limited amount of display space available to display information. Information can include content items related to specific geographic locations, educational information, information about businesses in the area, directions, or other map related information. The present disclosure provides for generating additional display space (e.g., content slots) within a map user interface to be utilized to display more information without obstructing the display of information associated with the underlying map user interface (e.g., navigation, directions, main streets, etc.).

In some implementations, the present disclosure can provide for selection or generation of content item slots to be filled with content items via a map user interface. For instance, the content items can relate to a specific geographic area provided for display via a map user interface. In some implementations the content slots or content items can be generated using artificial intelligence. For instance, the computing system can detect a shape within the map user interface (e.g., navigation application). In response to detecting the shape within the navigation application, the system can determine that the shape resembles another shape. For instance, a plurality of geographic boundaries associated with water can resemble a profile view of a human. The computing system can generate a content item that presents in the shape of, or includes, a profile view of a human overlayed on the geographic boundaries. Additionally, or alternatively, the shape of a body of water can resemble an animal. The computing system can generate a content item that presents in the shape of, or includes, the animal that the body of water resembles.

The present disclosure provides for improved methods for increasing the display space in a user interface available for providing for display additional information in an otherwise restricted user interface display. Existing methods provide for rectilinear or standard shape content slots. The content slots are associated with a singular point on a map and do not adjust as a navigation application interface is adjusted (e.g., enlarging, rotating, etc.).

The present method allows for determination and generation of content slots that are multi-dimensional and can be adjusted based on chosen or generated content items. In some instances, content items can be generated utilizing generative artificial intelligence. For example, the generative models (e.g., generative machine learning, generative AI) can generate text, audio, visual, or other content items that are associated with a geographic location associated with a geographic content or some other context information. For instance, context information can be associated with a geographic location or a user device. In some instances, content selection can be a real-time content generation or selection process (e.g., bidding process). In some instances, content items can include emergency messages, informational information, historical data, advertisements, or data generated using generative models.

Existing methods allow for linking content items to single-dimension points associated with a map or geographic area. These points can serve as anchors for fixed dimension (e.g., rectilinear or icon) content items to be provided for display. This can allow for display of minimal information relating to the content item or geographic location via a user interface of a client device.

The present disclosure provides for a technical solution to this technical problem by providing an improved human-machine interface that assists the user to execute tasks using, or based, on presented content items. For instance, by determining additional content slots for displaying information, example interfaces provided by aspects of the present disclosure can aid the user's ability to engage with and control computing devices.

Additionally, computing resources can be saved by preventing the display of a content item that may be overridden by navigation instructions (and thus, not observed by an end user). Computing resources can be saved by preventing the display of a content item that provides information to a user that would obstruct the user's initial map application instance (e.g., obstructing roadways, obstructing directions). Computing resources can be saved by preventing the transmission of content items to a user that facilitate actions that the user is not presently able to perform. Additionally, the computing system can obtain data associated with a user response to various content item displays (e.g., continuing along the suggested route, taking a detour that aligns with the subject matter of the content item, taking a detour that does not align with the subject matter of the content item, and the like). Thus, the computing system can update a model (e.g., a machine-learned model) based on data indicative of performance of past displayed content items to improve the utilization of computing resources and bandwidth in future instances.

The improvements associated with the systems and methods discussed herein can be further understood with reference to the figures.

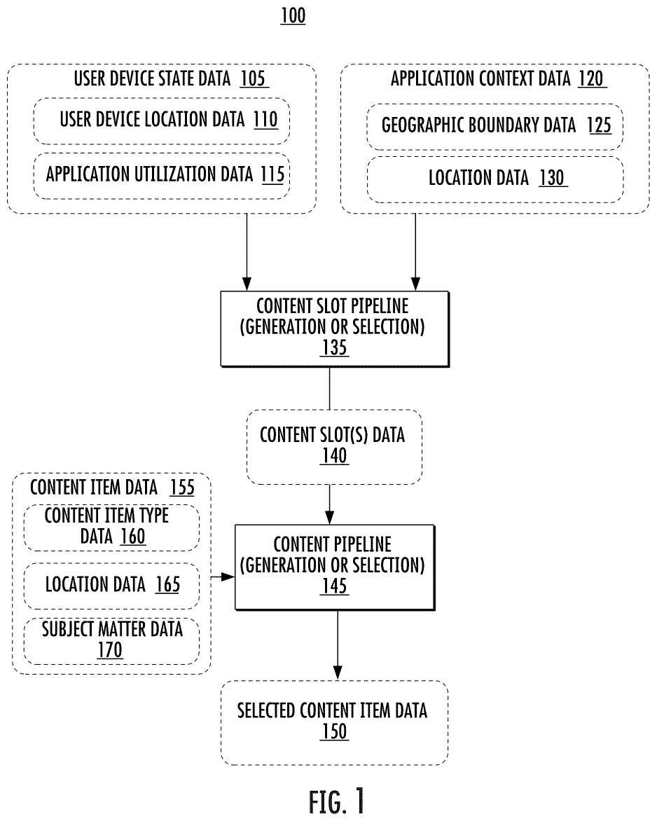

FIG. 1 depicts a block diagram of example data flow 100 according to example embodiments of the present disclosure. For instance a content slot pipeline 135 can obtain user device state data 105 and application context data 120 as input. Content slot pipeline 135 can generate content slot data 140 as output. Content pipeline 145 can obtain content slot data 140 or content item data 155 as input. Content pipeline 145 can select or generate selected content item data 150 as output. Data as described in FIG. 1 can be stored in one or more databases.

User device state data 105 can include user device location data 110 or application utilization data 115. User device location data 110 can include current location data, past location data, or second location data. Application utilization data 115 can include data associated with obtained user input relating to the application. For instance, the computing system can obtain data indicative of user input of manipulation of a user interface associated with a map application. In some implementations, input can be provided indicative of a user performing a search for a particular geographic area. In some instances, input can be provided indicative of a user initiating a navigation instance (e.g., getting directions from a first location to a second location). The application utilization data 115 can be indicative of a current type of utilization of an application by a user.

Application context data 120 can include geographic boundary data 125 and location data 130. Geographic boundary data 125 can be associated with geographic boundaries associated with a particular geographic area. For instance, geographic boundaries can include natural boundaries or man-made boundaries. Natural boundaries can include mountains, valleys, bodies of water, fields, wooded areas, or other geographic boundaries. Man-made boundaries can include roads, buildings, fences, bridges, or other man-made boundaries.

Location data 130 can include data indicative of the particular geographic area. For instance location data can include brick-and-mortar locations associated with an area, historical information associated with an area, or other subject matter related data. For instance, location data can include real-time location data associated with current events. For instance, if a farmer's market occurs every Saturday on three blocks of Main Street, this kind of information can be stored as location data. Or if there will be other temporary or permanent road closures or alterations to the geographic area. Location data 130 can include information associated with one or more stores in a geographic area. For instance, information could include type of business, hours of business, sales being run, menus, show times, or other similar information.

Content slot pipeline 135 can include a content slot model. Content slot pipeline can obtain user device state data 105 and application context data 120 as input and generate one or more content slots and associated content slot data 140 as output. In some implementations, content slot model can be a machine-learned model. Content slot model can generate one or more content slots according to example embodiments described herein.

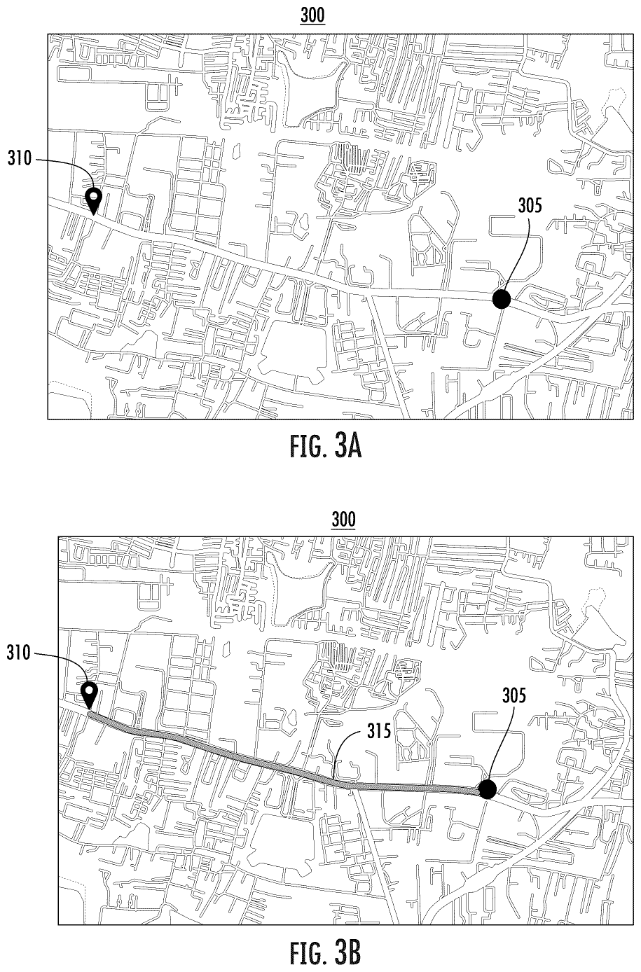

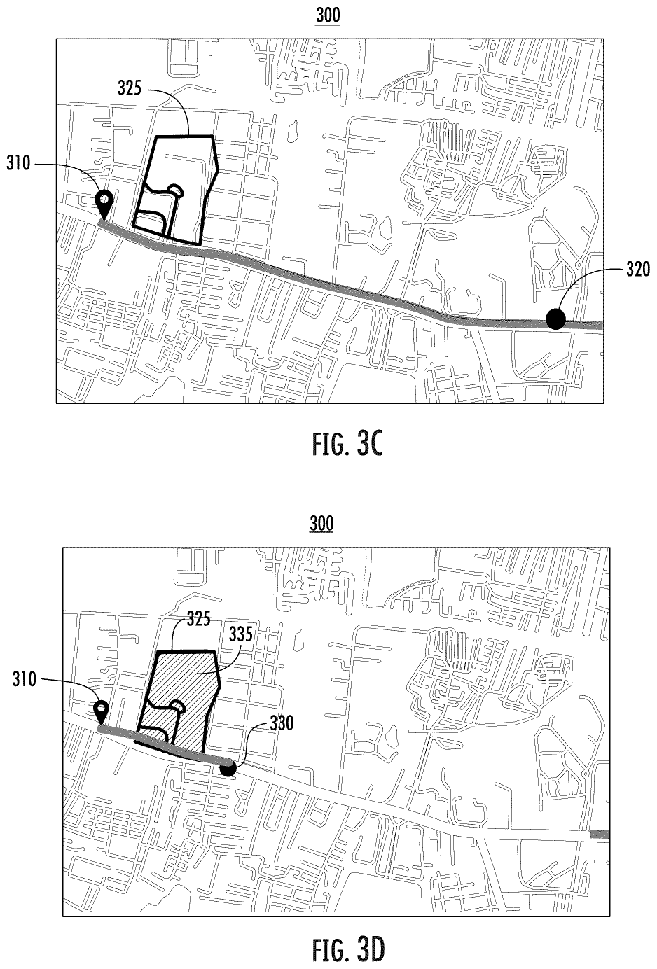

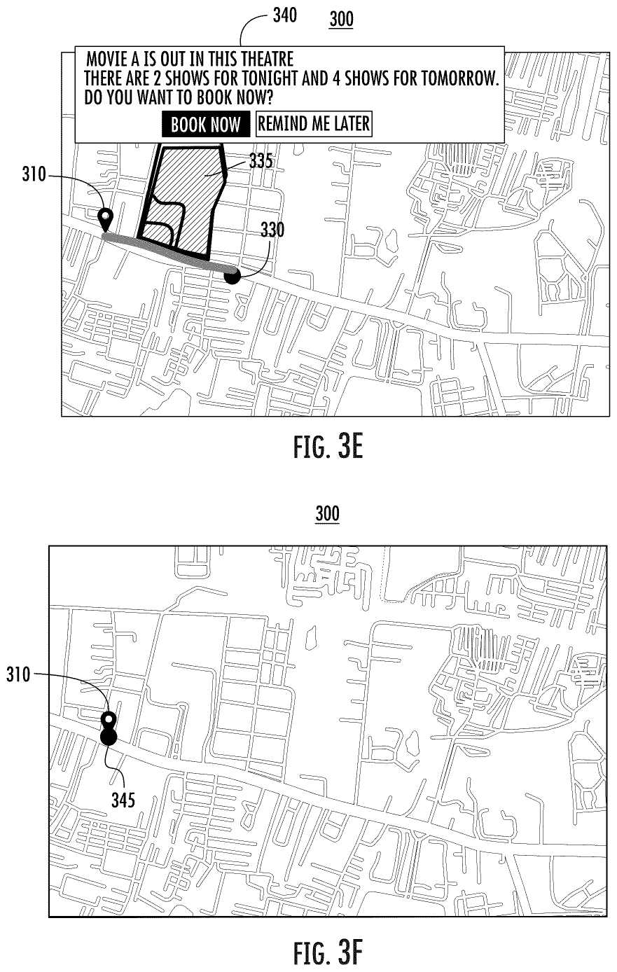

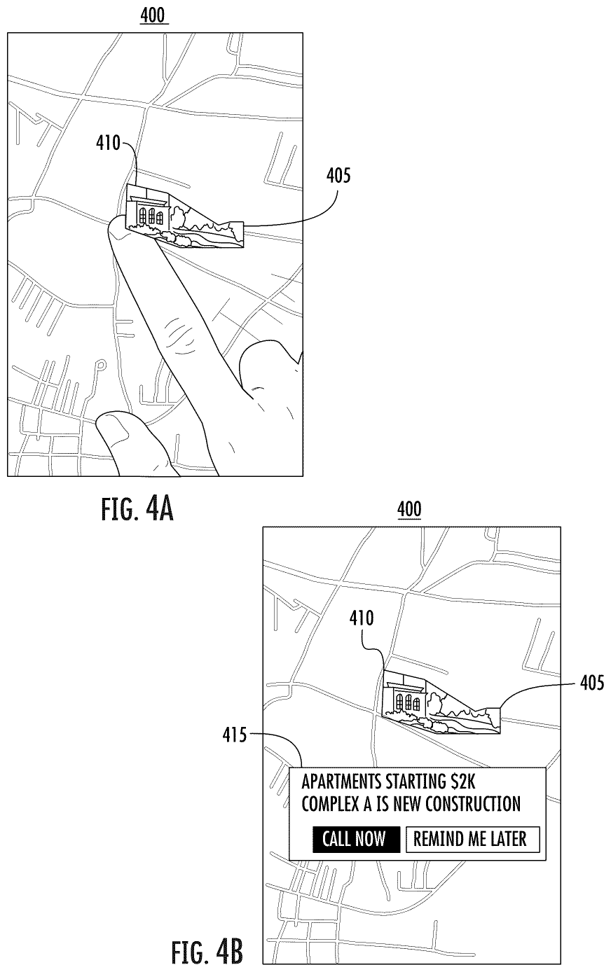

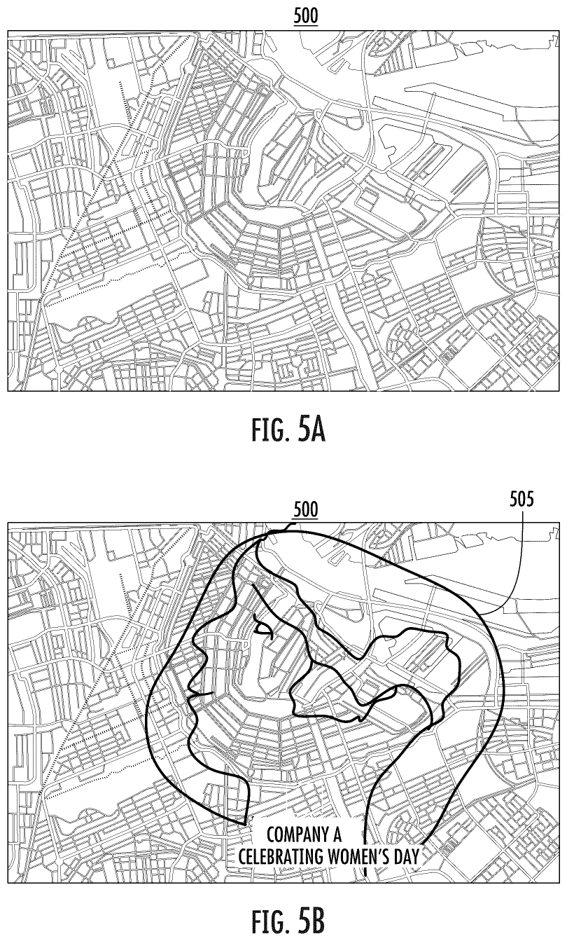

Content slot data 140 can include dimensions of a content slot that align with geographic bounds of a map user interface. For instance, the dimensions of the content slot can be multi-dimensional geographic bounds. A multi-dimensional geographic content slot can be a content slot that is defined by boundaries associated with real-world geographic boundaries. For instance, real-world geographic boundaries can include man-made boundaries or natural boundaries. By way of example, a multi-dimensional geographic content slot can be bound by the dimensions of a building, park, body of water, city comprising a plurality of roads, or any other geographic boundaries. Example geographic bounds are described herein (e.g. in FIG. 3A-E, FIG. 4A-B, or FIG. 5A-B).

Content pipeline 145 can include a content selection model or a content generation model. Content pipeline 145 can obtain content slot data 140 and content item data 155 and generate selected content item data 150 as output. Content pipeline 145 can generate or select one or more content items to fill one or more content slots. For instance, content pipeline 145 can use generative AI to generate content items in real time for the content slots. In some implementations, content selection model or content generation model can be a machine-learned model. Content selection model can select one or more content items according to example embodiments described herein.

Additionally, or alternatively, content pipeline 145 can select one or more content items for one or more content slots. In some implementations, the selected content items can be associated with specific geographic locations. In some implementations, the selected content items can be altered to be utilized within the multi-dimensional geographic content slots.

Content item data 155 can include content item type data 160, location data 165, or subject matter data 170. Content item data 155 can include data associated with a plurality of existing content items. In some implementations, content item data 155 can include data that can be used by content pipeline 145 to generate one or more content items. In some instances, existing content items can include a content item identifier data, location data 165, or subject matter data 170. Content item identifier data can be used to identify a respective content item. Location data 165 can include data associated with a physical location associated with the content item. For instance, a physical location can be associated with a brick-and-mortar location, a street address, latitude and longitude coordinates, GPS coordinates, or any other location data.

Subject matter data 170 can include subject matter associated with respective content items. For instance, subject matter data 170 can include data indicative of the contents of the content item, historical data, informational data. Subject matter data 170 can include data associated with particular physical locations.

The selected content item data 150 can be transmitted to a user device. For instance, the client device can obtain the selected content item data 150. Selected content item data 150 can include instructions that when executed cause the client device to present the content item for display via an interface of the client device (e.g., an image on a screen in a navigation application, and audiovisual item in a navigation application, a 3-dimensional holographic rendering).

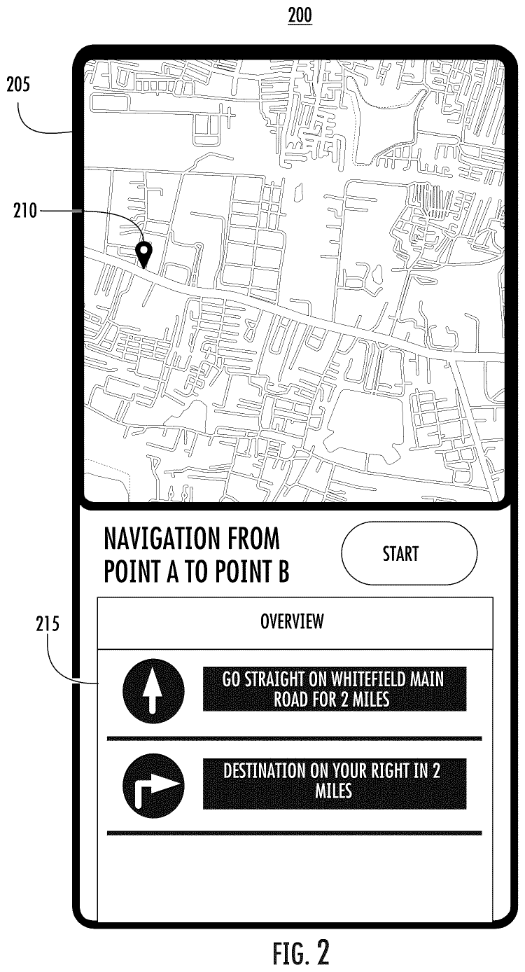

FIG. 2 depicts an example user interface 200 of a client device. The computing system can initiate a map instance (e.g., provide for display a map user interface) in response to obtaining user input selecting a map application. User interface 200 can include a navigation window 205 including an end location 210. As depicted in FIG. 2, the map instance can include a navigation instance. In some instances, the map instance can include an exploring instance. The description related to navigation instance can apply to the exploring instance and the description related to exploring instance can apply to navigation instance.

User interface 200 can include an example geographic area (e.g., navigation window 205) associated with an end location 210 associated with a user device's expected travel. Geographic area can include a plurality of physical locations with a plurality of offerings. For example, offerings can include entertainment, dining, shopping, services, museums, or other attractions. The plurality of physical locations can have associated content items that relate to the plurality of offerings (e.g., informational graphics, coupons, advertisements).

Navigation window 205 can include an overview of directions for a user to travel from a start location to an end location 210. In some implementations, navigation window 205 can be resized by the system to become smaller. Additionally or alternatively, navigation window 205 can be updated to display directions in real-time.

For instance, the computing device can obtain data indicative of an end location 210. The map instance can generate suggested route 215 for arriving from a first location (e.g., current geographic location) to an end location 210 (e.g., destination location).

User interface 200 can include an interface associated with a user actively utilizing a navigation feature of an application. For instance, the computing system can obtain data indicative of a user selecting a “Start Navigation” button. In response, the computing system can launch a navigation instance. The navigation instance can include a content slot, a recommended route, or notification window. Content slot can be invisible to a user until the computing system obtains data indicative of a current user location that triggers presentation of one or more content items via an interface of the user device. The suggested route 215 can be associated with an overall recommended route. Recommended route can be updated based on the computing system obtaining data of the user device's location being “off-route” (e.g., can provide a re-routing).

A navigation interface can be associated with a geographic area. Example geographic areas are discussed further with regard to FIG. 3A to FIG. 5B.

FIG. 3A to FIG. 3F depict an example map interface 300 according to example implementations described herein. FIG. 3A depicts a start location 305 and an end location 310.

FIG. 3B depicts example map interface 300 including a start location 305, an end location 310, and a suggested route 315. The computing system can determine that there are multiple geographic boundaries within map interface 300. In response, the computing system can initiate content slot pipeline to generate content slot data.

For instance, the computing system can obtain data indicative of a user initiating a map application instance on a client device. The map application instance can include a navigation instance or an explore instance. The computing system can determine one or more content slots for content items to populate. At least one content slot of the one or more content slots can include a multi-dimensional geographic content slot. The multi-dimensional geographic content slot can be a content slot that has boundaries that align with real-world geographic boundaries.

By way of example, the suggested route 315 can include a route recommended by a navigation application. In some implementations, a route recommended by a navigation application can include one or more routes recommended from a start location (e.g., start location 305) to an end location (e.g., end location 310). In some implementations, the computing system can provide a single suggested route. Additionally, or alternatively, the computing system can provide a plurality of suggested routes (e.g., for a user to select).

By way of example, the suggested route can include a frequently traveled route associated with the transit of the user device between two locations. In some implementations a frequently traveled route associated with transit of the user device between two locations can be a route that the computing system determines is frequently traveled by the user. By way of example, the computing system can determine that a start location is associated with a home location and an end location is associated with a grocery store. The computing system can analyze device location history to determine that the user device often travels from start location to end location on Sundays between 3:00 PM and 10:00 PM. The computing system can determine that the user takes the same route when traveling from start location to end location. As described herein start location and end location can be any location. In some implementations the start location or end location can be associated with a current location of a user device. In some implementations the start location or end location can be associated with a frequently visited location (e.g., determined based on determining a frequency of location pings at the same location).

By way of example, the suggested route can include a recommended route that aligns with one or more user preferences. For instance, user device data can indicate that a user device avoids traveling on interstates or highways. In response, the computing system can recommend routes that avoid interstates or highways.

In some instances, the suggested route can include a route that aligns with a public transit route. For instance, a public transit route can be associated with a bus system, metro, subway, or any other form of public transit. In some implementations, a user can utilize a navigation application that combines a plurality of modes of transportation (e.g., public transportation, walking, biking, scooter, electric vehicle, aerial vehicle, watercraft, etc.).

FIG. 3C depicts example map interface 300 including the end location 310, a current location 320, and a multi-dimensional geographic content slot 325. The computing system can generate content slot data including a size and dimensions of multi-dimensional geographic content slot 325. For instance, multi-dimensional geographic content slot 325 can align with the physical boundaries of a movie theater location.

In some instances, the multi-dimensional geographic content slot 325 can be determined by determining a first geographic boundary and a second geographic boundary. The computing system can generate a shape that aligns with the first geographic boundary and the second geographic boundary. The computing system can generate a content slot in the shape that aligns with the first geographic boundary and the second geographic boundary. The geographic boundaries can include at least one of (i) a road, (ii) a building, (iii) a body of water, (iv) a mountain, or (v) an undeveloped area.

By way of example, the first geographic boundary can include a road. Determining the content slot can include obtaining data indicative of an event that restricts the road to pedestrian-only use (e.g., a parade, farmers market, concert). In response to determining that the road is restricted to pedestrian-only use, the computing system can determine that the content slot can include the road without decreasing opacity of a content item to make the road visible via the user interface. In some instances, the computing system can generate a larger content slot that encompasses the road.

The map application instance can include a navigation instance. Determining the content slot can include determining a first content slot associated with a geographic location including a plurality of roads. At least one road of the plurality of roads can be associated with the navigation instance (e.g., part of the suggested route or an alternative route). The computing system can determine a second content slot associated with a geographic location including a water feature. The computing system can determine that populating the second content slot with an item would be less disruptive to the navigation instance than populating the first content slot (e.g., due to the first content slot containing the road associated with the navigation instance). The computing system can select the second content slot (e.g., associated with water feature) to display a content item based on the first content slot being associated with at least one road associated with the navigation instance.

The computing system can obtain content slot data from the content slot pipeline. The computing system can provide the content slot data as input into the content pipeline. The content pipeline can generate or select a content item to populate within multi-dimensional geographic content slot 325 as output. For instance, the computing system can determine a content item to populate within the content slot. By way of example, the content item for the content slot can be determined based on a real-time bidding process.

FIG. 3D depicts an example map interface 300 including the end location 310, a current location 330, and a content item 335 provided for display within multi-dimensional geographic content slot 325. In some instances, computing system can determine a multi-dimensional geographic content slot 325 at the start of a navigation instance. The computing system can wait until a user device current location 330 is close to the geographic location associated with multi-dimensional geographic content slot 325. In response to the user device current location 330 being with a threshold location, the computing system can provide for display content item 335 within multi-dimensional geographic content slot 325. For instance, the computing system can provide the content item to the client device to be displayed via the at least one content slot in a user interface of the client device associated with the map application instance.

As depicted in FIG. 3D, the multi-dimensional geographic content slot 325 can be generated to visually overlay on the map interface 300 without obstructing roads, navigation, or other geographic features. In some implementations, determining the content slot can include generating a content slot. For instance, the computing system can generate a content slot such that the content item provided to be displayed via the content slot will not obstruct the map application instance. For instance, the content slot does not overlap with or obstruct a road included in a suggested route. As described herein, the computing system can determine a content slot that does not overlay content on a road associated with a navigation instance (e.g., to prevent obstruction of directions or critical points of navigation).

In some implementations, a user can select or otherwise interact with content item 335. For instance, the computing system can obtain input data indicative of a user selecting content item 335. In response, the computing system can update the user interface.

For instance, as depicted in FIG. 3E, the computing system can provide for display updated interactive user interface element 340. Map interface 300 can be updated to include end location 310, current location 330, content item 335, and interactive user interface element 340. For instance, the interactive user interface element can provide additional information relating to content item 335. For instance, content item 335 can be associated with a movie (e.g., Movie A) that has recently been released.

Interactive user interface element 340 can provide information about the recently released movie and showtimes for the location associated with multi-dimensional geographic content slot 325. For instance, interactive user interface element 340 can include selectable elements including a “Book Now” and “Reminder Me Later” element. The computing system can obtain user input data indicative of a user selecting the “Book Now” or “Remind Me Later” element and perform operations in response.

By way of example “Book Now” can trigger processes of purchasing tickets for a show time, initiating a conversational interface (e.g., with an assistant) to obtain additional details needed for booking, or providing for display a third-party interface for booking or purchasing tickets.

By way of example, “Reminder Me Later” can trigger a process of setting a reminder or otherwise causing information relating to content item 335 to be provided for display via a user interface of the user device.

In some instances, the computing system can update map interface 300 in response to obtaining user input of a selection of interactive user interface element 340. Additionally, or alternatively, in response to determining there has been no user interaction with interactive user interface element 340 for a predetermined amount of time, the computing system can update map interface 300 to no longer display content item 335.

As depicted in FIG. 3F, map interface 300 can include a current location 345 that is the same as the end location 310. In some implementations, the computing system can determine that a user device has arrived at a destination location. In response to determining the user device has arrived at the destination location, the computing system can stop displaying content item 335 via map interface 300.

FIG. 4A and FIG. 4B depict example user interface 400. User interface 400 can be associated with a user exploring in a map application. As described herein, the map application instance can be an exploration instance. As depicted in FIG. 4A, the computing system can provide for display content item 410 within multi-dimensional content item slot 405. For instance, multi-dimensional content item slot 405 can be associated with apartments that are being built. Content item 410 can be associated with the apartments that are being built. In some implementations, computing system can obtain user input indicative of a user selecting content item 410.

In some implementations, the computing system can populate a plurality of content item slots with a plurality of determined content items. For instance, the geographic area could include multiple apartments, condos, or other available real estate. In response to determining that a user is exploring potential residential options (e.g., based on search history, current navigation of a user interface, and the like), the computing system can determine a plurality of content item slots associated with a plurality of available real estate locations. By way of example, the content item can be related in subject matter to the geographic area associated with the content slot. For instance, a menu of a restaurant being displayed within the geographic bounds of the restaurant, a preview of an informational web page providing historical context for a monument located in a state capitol, or some other related context.

Additionally, or alternatively, the computing system can determine a plurality of content items to populate within the respective content item slots. Due to the nature of the explore instance, the computing system can determine that it is appropriate to serve more than one content item via more than one content slot, whereas a navigation instance may be associated with more restrictions on the number or location of content items provided for display. For instance, the computing system can generate a content slot based on being at least one of (i) non-disturbing visually to a navigation instance, (ii) making use of a store location, or (iii) determining a geographic location is pedestrian only for predetermined length of time.

In response to obtaining user input indicative of a user selecting content item 410, the computing system can provide for display an interactive user interface element as depicted in FIG. 4B. For instance, the computing system can update user interface 400 to include interactive user interface element 415. For instance, interactive user interface element 415 can be associated with more information of the apartments described in content item 410. Interactive user interface element 415 can include information about a starting price of the apartments, that the apartments are new construction, or other related information. In some implementations, interactive user interface element 415 can include a “Call Now” or “Reminder Me Later” selectable element. In response to obtaining user input indicative of a selection of a “Call Now” or “Remind Me Later” selectable element, the computing system can perform operations.

For instance, in response to obtaining user input indicative of selection of “Call Now”, the computing system can launch a phone application to initiate a phone call for the location, initiate a chat with the apartment complex, or launch a website that provides more information about the apartment complex.

FIG. 5A and FIG. 5B depict example abstracted content items that are generated for a specific geographic area based on geographic boundaries. For instance, FIG. 5A depicts example geographic area 500. Geographic area 500 includes several water features that provide for concentric semi-circles. The computing system can determine (e.g., using image processing/AI) that the concentric circles resemble a profile view of a human head. In response, the computing system can generate (e.g., utilizing generative models, generative machine learning, generative AI), a content item that enhances the geographic boundaries and incorporates the geographic boundaries into the generated content item. The computing system can generate a content item for the content slot based on a shape of the content slot.

For instance, as depicted in FIG. 5B, the content item 505 can be associated with a celebration for women's day. Content item 505 can include an artistic rendering of a profile view of a woman overlayed on the concentric semi-circles. By way of example, in response to determining the content slot, the computing system can generate the content item using generative models (e.g., generative machine learning, generative AI). The generative models can include at least one of (i) image generation models, (ii) audio-visual generation models, or (iii) audio generation models.

Additionally, or alternatively, the shape of a body of water (or a green space on a map indicative of a forest, empty field, or some other area free of buildings) can resemble an animal. The computing system can generate a content item that presents in the shape of, or includes, the animal that the body of water resembles. For instance, the body of water can be in the shape of a dog's head. The computing system can determine that there is a doggy day care located within the geographic area and generate a content item that is in the shape of a dog head and includes information about the doggy day care. This example is presented for illustrative purposes only and is not meant to be limiting to the disclosure.

The computing system can determine an appropriate time to provide for display the content item. For instance, a user can be zoomed in on a particular section of the map. The computing system can obtain data indicative of the user zooming out to display the city at large. In response to determining that the user has zoomed out, the computing system can provide for display content item 505. In some implementations, if a user zooms back in, or otherwise provides input data indicative of content item 505 obstructing the underlying map layer, the computing system can cause content item 505 to disappear, increase the opacity, or perform some other manipulation to make the underlying map layer more prominent in the user interface.

As described herein, the computing system can determine that a map application has launched (e.g., a navigation application). The computing system can determine that the display of the navigation application has remained static for a threshold amount of time (e.g., a user has paused navigation, gone from zooming in and out to pausing at a certain zoom percentage). The computing system can compare the amount of time the display of the navigation application has remained static to a threshold amount of time (e.g., time associated with a certain action). The computing system can determine that the amount of time exceeds the threshold amount of time. In response to determining that the amount of time exceeds the threshold time, the computing system can determine one or more content slots or populate one or more determined content slots with content items.

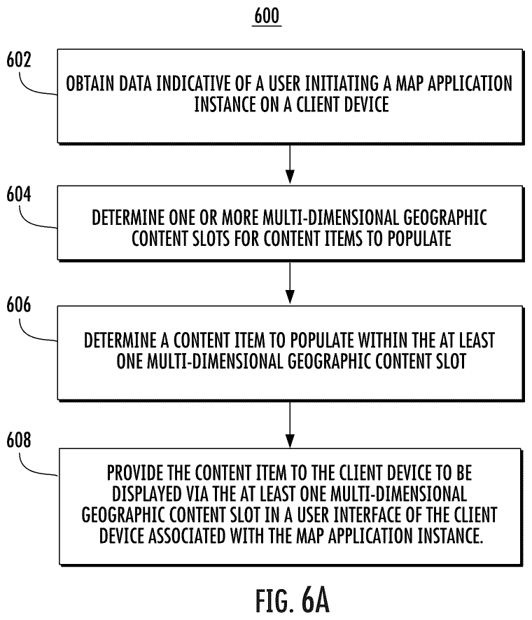

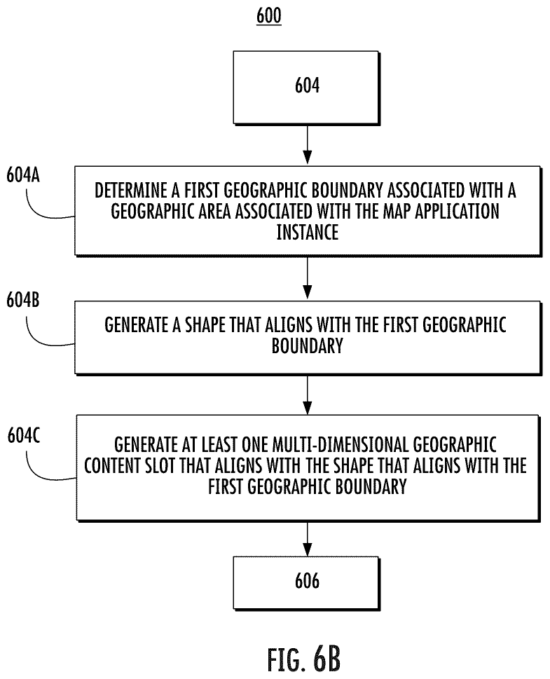

FIG. 6A and FIG. 6B depict flow chart diagrams of an example method 600 to perform multi-dimensional content slot generation and population according to example embodiments of the present disclosure. Although FIG. 6A and FIG. 6B depicts steps performed in a particular order for purposes of illustration and discussion, the methods of the present disclosure are not limited to the particularly illustrated order or arrangement. The various steps of method 600 can be omitted, rearranged, combined, or adapted in various ways without deviating from the scope of the present disclosure.

Turning to FIG. 6A, at (602), method 600 can include obtaining data indicative of a user initiating a session of a map application. A computing system can obtain data indicative of a user initiating a session of a map application. For instance, a client device can include a plurality of applications. The computing system can obtain user input indicative of selection of a map application. In response, the computing system can provide for display the map application via a user interface of the client device.

For instance, the map application can include a navigation application. The map instance can include a navigation instance or an exploration instance.

At (604), method 600 can include determining one or more content slots for content items to populate. A computing system can determine one or more content slots for content items to populate. The one or more content slots include a multi-dimensional space in the map application. Determining one or more content slots can include selecting or generating one or more content slots.

For instance, content slots can be generated based on user device state data and application context data. For instance, a state of a user device can include at least one of user device location data or application utilization data. Application context data can include geographic boundary data or location data.

As described herein, user device location data can include a current location of a user device. For instance, a current location of a user device can be determined using geographic location can be associated with a brick-and-mortar location, a street address, latitude and longitude coordinates, global position system (GPS) data, Wi-Fi data, mobile network data, device sensor data, Bluetooth data, user input, or any other location data.

Application utilization data can include data associated with obtained user input relating to the application. For instance, the computing system can obtain data indicative of user input of manipulation of a user interface associated with a map application. In some implementations, input can be provided indicative of a user performing a search for a particular geographic area. In some instances, input can be provided indicative of a user initiating a navigation instance (e.g., getting directions from a first location to a second location). The application utilization data (e.g., application utilization data 115) can be indicative of a current type of utilization of an application by a user.

By way of example, a client device can be in an active instance of a map or navigation application. For instance, the instance can be an exploring instance. The computing system can determine that there has been user input indicative of a search for a particular geographic area. The computing system can determine one or more geographic boundaries in the particular geographic area. The computing system can generate one or more multi-dimensional geographic content slots.

As depicted in FIG. 6B, step (604) of method 600 can include steps (604A) to (604B). At (604A), method 600 can include determining a first geographic boundary associated with a geographic area associated with the map application instance. For instance, the first geographic boundary can be associated with a real-world geographic boundary.

At (604B), method 600 can include generating a shape that aligns with the first geographic boundary. By way of example, FIG. 3C includes a plurality of geographic boundaries that are associated with the real-world boundaries of a movie theater building, FIG. 4A and FIG. 4B depict a plurality of geographic boundaries that are associated with the real-world boundaries of an apartment building, and FIG. 5B depicts a plurality of geographic boundaries that are associated with real-world boundaries associated with water channels in a geographic area.

At (604C), method 600 can include generating at least one multi-dimensional geographic content slot that aligns with the shape that aligns with the first geographic boundary. For instance, FIG. 3C includes multi-dimensional content slot 325 that corresponds to the real-world boundaries of the movie theater building, FIG. 4B includes multi-dimensional content slot 405 that corresponds to the real-world boundaries of the apartment building, and FIG. 5B depicts content item 505 within a multi-dimensional content slot that corresponds with real-world boundaries of an area of a city.

Turning back to FIG. 6A, at (606), method 600 can include determining a content item to populate within the at least one multi-dimensional geographic content slot. A computing system can determine a content item to populate within the at least one multi-dimensional geographic content slot. As described herein, the computing system can determine a content item to populate within the at least one multi-dimensional geographic content slot based on content slot data or content item data. In some instances,

Content slot data can include data indicative of a content slot for providing for display a content item via a user interface of the user device based on the state of the user device and the suggested route. For instance, the computing system can obtain content slot data indicative of a content slot for providing for display a content item via a user interface of the user device based on the state of the user device and the application context data.

As described herein, determining a content item to populate within the content slot can include generating a new content item or selecting an existing content item. For instance, the content item can be selected from a plurality of candidate content items. The plurality of candidate content items can be associated with a plurality of physical locations. For example, the physical locations can be locations associated with a geographic area (e.g., as described in FIG. 2, FIG. 3A-E, FIG. 4A-B, or FIG. 5A-B).

In some instances, the computing system can identify an existing content item including a plurality of portions. For instance, the content item can include a text portion, a graphical portion, an image portion, or other portions. The computing system can analyze the content item (e.g., using image processing or natural language processing). The computing system can determine a portion of the content item containing information of interest. The information of interest could include showtimes for a movie, prices on a menu, important dates associated with a historical location, or other information of interest.

The computing system can determine that at least one content slot is a shape that would crop the content item to exclude the portion of the content item containing the information of interest. In response to determining the content slot shape would result in cropping the content item to exclude the portion of interest, the computing system can generate a new content item in the shape of the content slot in a manner that includes the information of interest.

By way of example, generating the new content item in the shape of the content slot that includes the information of interest can include extracting text from the existing content item. Generating the new content item can include extracting an image from the existing content item. Generating the new content item can include creating the new content item to include the extracted text and the extracted image from the existing content item.

In some instances, content items can be generated based on at least one of (i) content slot data, (ii) user data, or (iii) personalized user information. For instance, the computing system can generate custom content items based on user preferences or information relating to the geographic area. By way of example, a physical location could include multiple store fronts with ranging available products or services. For instance, the store could include a sports shop, a nail salon, a roof-top restaurant, and a fast-food chain. The computing system can determine that a user associated with the current map instance has a preference for sports and fast-food. In response, the computing system can generate a content item that relates to the sports shop or the fast-food restaurant instead of one of the other stores located in that physical area.

In some implementations, the content item can be selected or generated by content pipeline. For instance, content pipeline can obtain content slot data (e.g., content slot data 140) and content item data (e.g., selected content item data 150).

By way of example, the computing system can determine one or more relevant content items associated with one or more physical locations to provide for display via a user device. For instance, the content items can include one or more interactive elements. Upon receipt of data indicative of a user selecting an interactive element of a content item, the computing system can automatically initiate a navigation instance. The navigation instance can include a navigation to a physical location associated with the content item being provided for display via a navigation interface of the user device. In some implementations, interaction with a content item can result in the user device providing for display a content item in an interface outside of the navigation interface to provide additional information related to the content item (e.g., a link to a website, launching an application). Additionally, or alternatively, interaction with the content item can result in the user device providing for display further information related to the content item within the navigation interface.

Content item pipeline can include a content selection component or content generation component. Content selection component can incorporate additional or alternative considerations in selecting content. For instance, content selection component can include participation in a real-time content selection process (e.g., proposals for resource allocation, bids, etc.). Content selection can include selecting one or more digital components or content items. Content items can include, for example input elements, digital components, and the like. For instance, content items can be provided by entities and can be related to a particular topic, object, product, or service.

The content item can be selected using a machine-learned model. For instance, the computing system can obtain data indicative of user interaction with one or more content items, The computing system can obtain data indicative of a user performing one or more target actions. The computing system can update the machine learned model based on the data indicative of the user interaction with the one or more content items and the data indicative of the user performing one or more target actions.

For example, updating an existing content item can include obtaining a rectilinear content item. In some implementations, the computing system can determine that the content slot is an abnormal shape. The computing system can determine that superimposing the content item within the content slot would result in cropping information from the content item that needs to be displayed. In response, the computing system can update the content slot to display the key portion (e.g., portion containing information of interest) within the multi-dimensional geographic content slot.

At (608), method 600 can include providing the content item to the client device to be displayed via the at least one multi-dimensional geographic content slot in a user interface of the client device associated with the map application instance. The computing system can provide the content item to the client device to be displayed via the at least one multi-dimensional geographic content slot in a user interface of the client device associated with the map application instance. For instance, method 600 can include transmitting data comprising instructions that when executed by the client device cause the content item to be provided for display via the at least one multi-dimensional geographic content slot of the client device.

In some instances, the instructions can include instructions relating to the presentation of the content item via the content slot. For instance, the presentation can include adjusting the transparency of a content item to overlay the content item where the content item and the underlying map can be seen simultaneously. In some implementations, presentation can include adjusting certain geographic features to make the features more visually prominent (e.g., darker color, darker borders, or cutting out certain portions of a content item). For instance, the user interface can include a plurality of colors, hashes, border thicknesses, font, or other visual features to allow for content to overlay with the background map layer without compromising the utility of the background layer.

Additionally, or alternatively, content items can include animated content items. For instance, the content item can be a video. In some implementations, the computing system can provide the content item for display, allow the content item to play, and then cause the content item to disappear (e.g., reverting back to the map application/background layer).

In some implementations, the content item can be a 3-D holographic content item. The 3-D holographic content item can include graphics that are different based on the perspective from which they are observed (e.g., a side view differs from a top view).

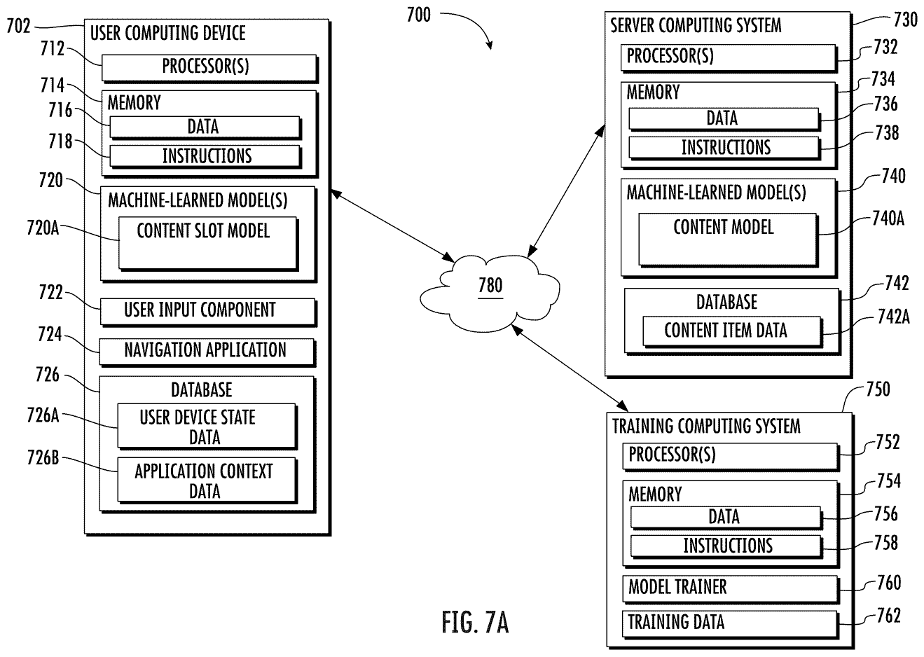

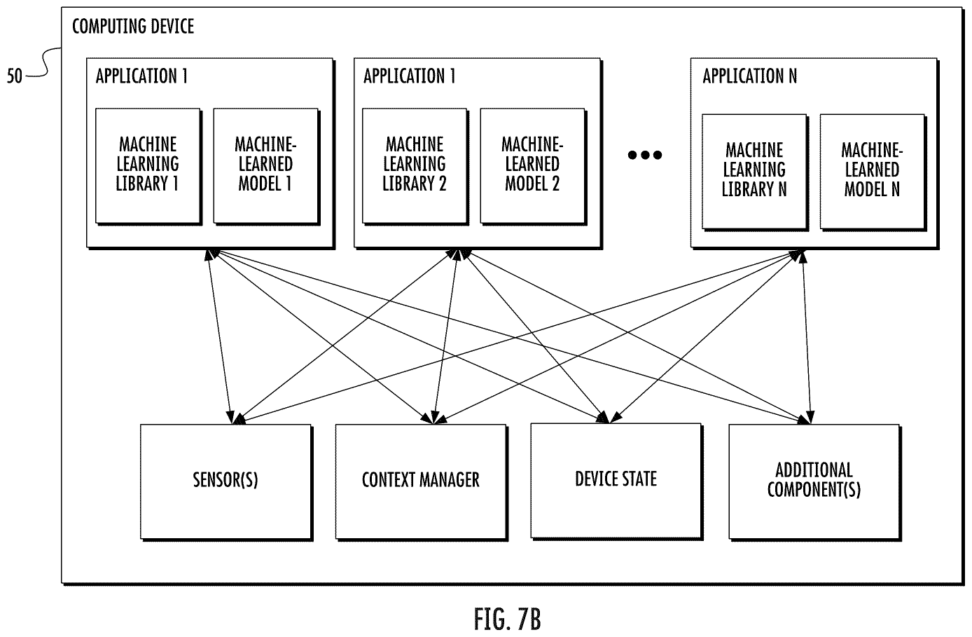

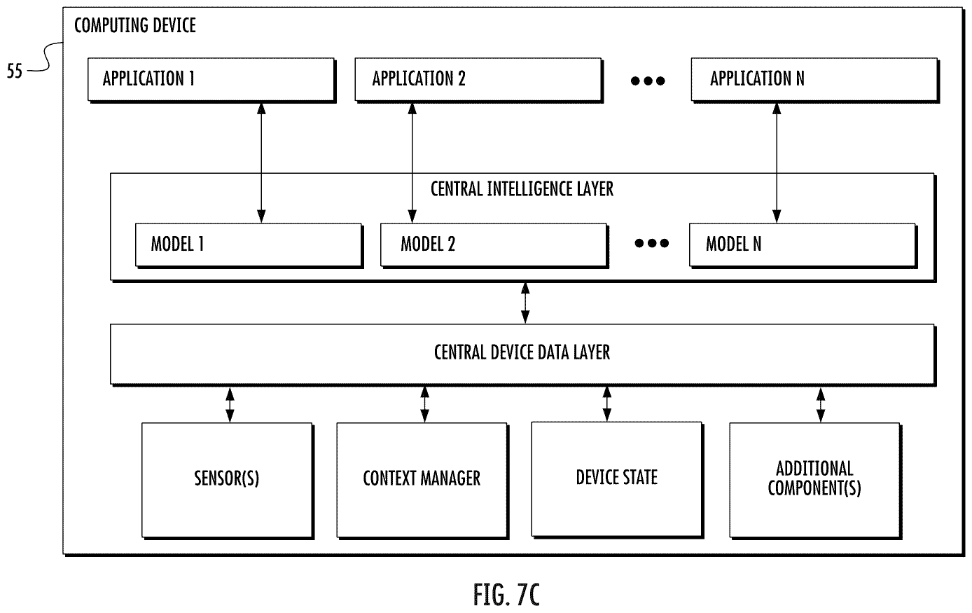

FIG. 7A depicts a block diagram of an example computing system 700 that performs generation of multi-dimensional content slots to increase display availability of user interfaces according to example embodiments of the present disclosure. The computing system 700 includes a user computing device 702, a server computing system 730, and a training computing system 750 that are communicatively coupled over a network 780.

The user computing device 702 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 702 includes one or more processors 712 and a memory 714. The one or more processors 712 can be any suitable processing device (e.g., a processor core, a microprocessor, an ASIC, an FPGA, a controller, a microcontroller, etc.) and can be one processor or a plurality of processors that are operatively connected. The memory 714 can include one or more non-transitory computer-readable storage media, such as RAM, ROM, EEPROM, EPROM, flash memory devices, magnetic disks, etc., and combinations thereof. The memory 714 can store data 716 and instructions 718 which are executed by the processor 712 to cause the user computing device 702 to perform operations.

In some implementations, the user computing device 702 can store or include one or more models 720. For example, the models 720 can be or can otherwise include various machine-learned models such as neural networks (e.g., deep neural networks) or other types of machine-learned models, including non-linear models or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 720 are discussed with reference to FIG. 1, FIG. 2, FIG. 3A-E, FIG. 4A-B and FIG. 5A-B. In some implementations, example models 720 can include generative artificial intelligence models. For instance, generative AI models can include chat bots, models that generate text, large language models, models that generate images, or models that generate videos.

In some implementations, the one or more content slot models 720A can be received from the server computing system 730 over network 780, stored in the user computing device memory 714, and then used or otherwise implemented by the one or more processors 712. In some implementations, the user computing device 702 can implement multiple parallel instances of a single content slot model 720A.

More particularly, models 720 can include content slot models or content selection models. For instance, models can be utilized to determine the placement of a content item slot or selection of one or more content items to be provided for display (e.g., to a user based on navigational or contextual data).

Additionally or alternatively, one or more models 740 can be included in or otherwise stored and implemented by the server computing system 730 that communicates with the user computing device 702 according to a client-server relationship. For example, the models 740 can be implemented by the server computing system 730 as a portion of a web service (e.g., a content management service, content selection service, content generation service). Thus, one or more models 720 can be stored and implemented at the user computing device 702 or one or more models 740 can be stored and implemented at the server computing system 730. For instance, models 740 can include content model 740A.

The user computing device 702 can also include one or more user input components 722 that receives user input. For example, the user input component 722 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The user computing device 702 can also include one or more navigation components. For example, navigation components can include navigation application 724.

The user computing device 702 can include database 726. Database 726 can include user device state data 726A or application context data 726B.

The server computing system 730 includes one or more processors 732 and a memory 734. The one or more processors 732 can be any suitable processing device (e.g., a processor core, a microprocessor, an ASIC, an FPGA, a controller, a microcontroller, etc.) and can be one processor or a plurality of processors that are operatively connected. The memory 734 can include one or more non-transitory computer-readable storage media, such as RAM, ROM, EEPROM, EPROM, flash memory devices, magnetic disks, etc., and combinations thereof. The memory 734 can store data 736 and instructions 738 which are executed by the processor 732 to cause the server computing system 730 to perform operations.

In some implementations, the server computing system 730 includes or is otherwise implemented by one or more server computing devices. In instances in which the server computing system 730 includes plural server computing devices, such server computing devices can operate according to sequential computing architectures, parallel computing architectures, or some combination thereof.

As described above, the server computing system 730 can store or otherwise include one or more models 740. For example, the models 740 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). In some implementations, models 740 can include generative models (e.g., generative artificial intelligence models). Models 740 can include content model 740A. Content model 740A can be configured to generate or select one or more content items to be provided for display (e.g., via a content slot generated by content slot model 720A). Example models 740 are discussed with reference to FIG. 1, FIG. 2, FIG. 3A-E, FIG. 4A-B, and FIG. 5A-B.

Server computing system 730 can include database 742. Database 742 can store content item data 742A. In some implementations, server computing system 730 can interface with one or more third-party computing systems to obtain content item data 742A.

The user computing device 702 or the server computing system 730 can train the models 720 or 740 via interaction with the training computing system 750 that is communicatively coupled over the network 780. The training computing system 750 can be separate from the server computing system 730 or can be a portion of the server computing system 730.

The training computing system 750 includes one or more processors 752 and a memory 754. The one or more processors 752 can be any suitable processing device (e.g., a processor core, a microprocessor, an ASIC, an FPGA, a controller, a microcontroller, etc.) and can be one processor or a plurality of processors that are operatively connected. The memory 754 can include one or more non-transitory computer-readable storage media, such as RAM, ROM, EEPROM, EPROM, flash memory devices, magnetic disks, etc., and combinations thereof. The memory 754 can store data 756 and instructions 758 which are executed by the processor 752 to cause the training computing system 750 to perform operations. In some implementations, the training computing system 750 includes or is otherwise implemented by one or more server computing devices.

The training computing system 750 can include a model trainer 760 that trains the models 720 or 740 stored at the user computing device 702 or the server computing system 730 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, or various other loss functions. Gradient descent techniques can be used to iteratively update the parameters over a number of training iterations.

In some implementations, performing backwards propagation of errors can include performing truncated backpropagation through time. The model trainer 760 can perform a number of generalization techniques (e.g., weight decays, dropouts, etc.) to improve the generalization capability of the models being trained.

In particular, the model trainer 760 can train the models 720 or 740 based on a set of training data 762. The training data 762 can include, for example, training data can include user input data, conversion data, user device location data, click data, or other data indicative of a content item being displayed via a user device and the user device performing a target action (e.g., visiting a physical location associated with the respective content item).

In some implementations, if the user has provided consent, the training examples can be provided by the user computing device 702. Thus, in such implementations, the models 720 provided to the user computing device 702 can be trained by the training computing system 750 on user-specific data received from the user computing device 702. In some instances, this process can be referred to as personalizing the model.

The model trainer 760 includes computer logic utilized to provide desired functionality. The model trainer 760 can be implemented in hardware, firmware, or software controlling a general purpose processor. For example, in some implementations, the model trainer 760 includes program files stored on a storage device, loaded into a memory and executed by one or more processors. In other implementations, the model trainer 760 includes one or more sets of computer-executable instructions that are stored in a tangible computer-readable storage medium such as RAM, hard disk, or optical or magnetic media.

The network 780 can be any type of communications network, such as a local area network (e.g., intranet), wide area network (e.g., Internet), or some combination thereof and can include any number of wired or wireless links. In general, communication over the network 780 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The machine-learned models described in this specification may be used in a variety of tasks, applications, or use cases.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable or efficient transmission or storage (or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 7A illustrates one example computing system that can be used to implement the present disclosure. Other computing systems can be used as well. For example, in some implementations, the user computing device 702 can include the model trainer 760 and the training data 762. In such implementations, the models 720 can be both trained and used locally at the user computing device 702. In some of such implementations, the user computing device 702 can implement the model trainer 760 to personalize the models 720 based on user-specific data.

FIG. 7B depicts a block diagram of an example computing device 50 that performs generation of multi-dimensional content slots to increase display availability of user interfaces according to example embodiments of the present disclosure. The computing device 50 can be a user computing device or a server computing device.

The computing device 50 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 7B, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 7C depicts a block diagram of an example computing device 55 that performs according to example embodiments of the present disclosure. The computing device 55 can be a user computing device or a server computing device.

The computing device 55 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 7C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 55.

The central intelligence layer can communicate with a central device data layer. The central device data layer can be a centralized repository of data for the computing device 55. As illustrated in FIG. 7C, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

The depicted or described steps are merely illustrative and can be omitted, combined, or performed in an order other than that depicted or described; the numbering of depicted steps is merely for ease of reference and does not imply any particular ordering is necessary or preferred.

The functions or steps described herein can be embodied in computer-usable data or computer-executable instructions, executed by one or more computers or other devices to perform one or more functions described herein. Generally, such data or instructions include routines, programs, objects, components, data structures, or the like that perform particular tasks or implement particular data types when executed by one or more processors in a computer or other data-processing device. The computer-executable instructions can be stored on a computer-readable medium such as a hard disk, optical disk, removable storage media, solid-state memory, read-only memory (ROM), random-access memory (RAM), or the like. As will be appreciated, the functionality of such instructions can be combined or distributed as desired. In addition, the functionality can be embodied in whole or in part in firmware or hardware equivalents, such as integrated circuits, application-specific integrated circuits (ASICs), field-programmable gate arrays (FPGAs), or the like. Particular data structures can be used to implement one or more aspects of the disclosure more effectively, and such data structures are contemplated to be within the scope of computer-executable instructions or computer-usable data described herein.

Although not required, one of ordinary skill in the art will appreciate that various aspects described herein can be embodied as a method, system, apparatus, or one or more computer-readable media storing computer-executable instructions. Accordingly, aspects can take the form of an entirely hardware embodiment, an entirely software embodiment, an entirely firmware embodiment, or an embodiment combining software, hardware, or firmware aspects in any combination.

As described herein, the various methods and acts can be operative across one or more computing devices or networks. The functionality can be distributed in any manner or can be located in a single computing device (e.g., server, client computer, user device, or the like).

Aspects of the disclosure have been described in terms of illustrative embodiments thereof. Numerous other embodiments, modifications, or variations within the scope and spirit of the appended claims can occur to persons of ordinary skill in the art from a review of this disclosure. For example, one or ordinary skill in the art can appreciate that the steps depicted or described can be performed in other than the recited order or that one or more illustrated steps can be optional or combined. Any and all features in the following claims can be combined or rearranged in any way possible.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, or equivalents to such embodiments. Accordingly, the subject disclosure does not preclude inclusion of such modifications, variations, or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, or equivalents.

1. A computer-implemented method, comprising:
obtaining, by a computing system, data indicative of a user initiating a map application instance on a client device;
determining, by the computing system, one or more multi-dimensional geographic content slots for content items to populate by:
determining a first geographic boundary associated with a geographic area associated with the map application instance;
generating a shape that aligns with the first geographic boundary; and
generating at least one multi-dimensional geographic content slot that aligns with the shape that aligns with the first geographic boundary;
determining, by the computing system, a content item to populate within the at least one multi-dimensional geographic content slot; and
providing the content item to the client device to be displayed via the at least one multi-dimensional geographic content slot in a user interface of the client device associated with the map application instance.

2. The computer-implemented method of claim 1, wherein determining the one or more multi-dimensional geographic content slots for the content items to populate comprises, generating a multi-dimensional geographic content slot such that the content item provided to be displayed via the multi-dimensional geographic content slot will not obstruct the map application instance.

3. The computer-implemented method of claim 1, comprising:
in response to determining the at least one multi-dimensional geographic content slot, generating the content item using a generative model.

4. The computer-implemented method of claim 3, wherein the generative model comprises at least one of (i) image generation model, (ii) audio-visual generation model, or (iii) audio generation model.

5. The computer-implemented method of claim 1, wherein determining the one or more multi-dimensional geographic content slots for the content items to populate further comprises:
determining a second geographic boundary;
generating a shape that aligns with the second geographic boundary; and
generating a multi-dimensional geographic content slot in the shape that aligns with the second geographic boundary.

6. The computer-implemented method of claim 5, wherein at least one of the first geographic boundary or the second geographic boundary comprises at least one of (i) a road, (ii) a building, (iii) a body of water, (iv) a mountain, or (v) an undeveloped area.

7. The computer-implemented method of claim 6, wherein the first geographic boundary comprises a road, and wherein determining the one or more multi-dimensional geographic content slots comprises:
obtaining data indicative of an event that restricts the road to pedestrian-only use; and
in response to obtaining the data indicative of the event that restricts the road to pedestrian-only use, determining that the multi-dimensional geographic content slot can include the road without decreasing opacity of the content item to make the road visible via the user interface.

8. The computer-implemented method of claim 1, wherein the map application instance comprises a navigation instance, and wherein determining the one or more multi-dimensional geographic content slots for content items to populate comprises:
determining a first multi-dimensional geographic content slot associated with a geographic location comprising a plurality of roads, wherein at least one road of the plurality of roads is associated with the navigation instance;
determining a second multi-dimensional geographic content slot associated with the geographic location comprising a water feature; and
selecting the second multi-dimensional geographic content slot to display a content item based on the first multi-dimensional geographic content slot being associated with the at least one road associated with the navigation instance.

9. The computer-implemented method of claim 1, wherein the content item for the at least one multi-dimensional geographic content slot is determined based on a real-time bidding process.

10. The computer-implemented method of claim 1, wherein the content item is related in subject matter to a geographic area associated with the at least one multi-dimensional geographic content slot.

11. The computer-implemented method of claim 1, wherein the at least one multi-dimensional geographic content slot is generated based on being at least one of (i) non-disturbing visually to a navigation instance, (ii) making use of a store location, or (iii) determining a geographic location is pedestrian only for predetermined length of time.

12. The computer-implemented method of claim 1, comprising:
determining that the map application instance is an exploration instance; and
in response to determining the map application instance is an exploration instance, populating a plurality of the one or more multi-dimensional geographic content item slots with a plurality of determined content items.

13. The method of claim 1, comprising:
determining that the map application instance is a navigation instance; and
in response to determining that the map application instance is a navigation instance, determining the at least one content slot that does not overlay content on a road associated with the navigation instance.

14. The method of claim 1, comprising:
determining that a navigation application has launched;
determining that the display of the navigation application has remained static for a threshold amount of time;
comparing the amount of time to the threshold amount of time;
determining the amount of time exceeds the threshold amount of time; and
in response to determining that the amount of time exceeds the threshold time, determining the one or more content item slots.

15. The method of claim 1, wherein determining the content item to populate within the at least one multi-dimensional geographic content slot comprises:
generating the content item for the at least one multi-dimensional geographic content slot based on a shape of the at least one multi-dimensional geographic content slot.

16. The method of claim 1, wherein determining the content item to populate within the at least one multi-dimensional geographic content slot comprises:
identifying an existing content item comprising a plurality of portions;
determining, by analyzing the content item, a portion of the content item containing information of interest;
determining the at least one multi-dimensional geographic content slot is a shape that would crop the content item to exclude the portion of the content item containing information of interest; and
in response to determining the at least one multi-dimensional geographic content slot shape would crop the content item to exclude the portion of the content item containing information of interest, generating a new content item in the shape of the at least one multi-dimensional geographic content slot that includes the information of interest.

17. The method of claim 16, wherein generating a new content item in the shape of the at least one multi-dimensional geographic content slot that includes the information of interest comprises:
extracting text from the existing content item;
extracting an image from the existing content item; and
generating the new content item to include the extracted text and extracted image from the existing content item.

18. The method of claim 1, wherein determining the content item to populate within the at least one multi-dimensional geographic content slot comprises:
generating the content item based on at least one of (i) content slot data, (ii) user data, or (iii) personalized user information.

19. A computing system, comprising:
one or more processors; and
one or more computer-readable media storing instructions that are executable to cause the one or more processors to perform operations, the operations comprising:
obtaining, by a computing system, data indicative of a user initiating a map application instance on a client device:
determining, by the computing system, one or more multi-dimensional geographic content slots for content items to populate by:
determining a first geographic boundary associated with a geographic area associated with the map application instance:
generating a shape that aligns with the first geographic boundary; and
generating at least one multi-dimensional geographic content slot that aligns with the shape that aligns with the first geographic boundary;
determining, by the computing system, a content item to populate within the at least one multi-dimensional geographic content slot; and
providing the content item to the client device to be displayed via the at least one multi-dimensional geographic content slot in a user interface of the client device associated with the map application instance.

20. One or more non-transitory computer readable media storing instructions that are executable by one or more processors to perform operations comprising:
obtaining, by a computing system, data indicative of a user initiating a map application instance on a client device:
determining, by the computing system, one or more multi-dimensional geographic content slots for content items to populate by:
determining a first geographic boundary associated with a geographic area associated with the map application instance:
generating a shape that aligns with the first geographic boundary; and
generating at least one multi-dimensional geographic content slot that aligns with the shape that aligns with the first geographic boundary;
determining, by the computing system, a content item to populate within the at least one multi-dimensional geographic content slot; and
providing the content item to the client device to be displayed via the at least one multi-dimensional geographic content slot in a user interface of the client device associated with the map application instance.
